(19) United States
(12) Patent Application Publication
(10) Pub. No.: US 2016/0193684 A1
(43) Pub. Date: Jul. 7, 2016

(54) FORMING AND FEEDING DEVICE OF FILLER METAL FOR TIG WELDING

(71) Applicant: PUKYONG NATIONAL UNIVERSITY INDUSTRY-UNIVERSITY COOPERATION FOUNDATION, Busan (KR)

(72) Inventors: Sang-Myung Cho, Busan (KR); Jae-Ho Jun, Busan (KR); Jae-Gyu Byun, Busan (KR)

(73) Assignee: Pukyong National University Industry-University Cooperation Foundation, Busan (KR)

(21) Appl. No.: 14/912,902

(22) PCT Filed: Dec. 3, 2013
(86) PCT No.: PCT/KR2013/011119

§ 371 Date: Feb. 18, 2016

(30) Foreign Application Priority Data
Aug. 20, 2013 (KR) 10-2013-0098331

(51) Int. Cl. B23K 9/12; B23K 9/133

(52) U.S. Cl. CPC B23K 9/125; B23K 9/133

(57) ABSTRACT

To achieve the above, the present invention provides a forming and feeding device of a filler metal for TIG welding which presses a filler metal of plane shape to form as curved cross-section which includes a case; a guide member installed on a front part of the case to guide the filler metal; a rotation roller revolving by a motor to feed the filler metal with supporting a lower surface of the filler metal, the filler metal guided by the guide member; a press roller located over the rotation roller to press a upper surface of the filler metal which is in contact with the rotation roller; and a press member pressing the press roller.

### TECHNICAL FIELD

The present invention relates to a forming and feeding device of a filler metal for TIG welding, and more specifically relates to a forming and feeding device of a filler metal for TIG welding which forms the filler metal having rectangular cross-section into curved cross-section followed by feeding the filler metal.

### BACKGROUND ART

In general, low-grade material such as carbon steel is mainly used for pipe equipment of electricity facilities, ocean plants or petrochemical plants, and an overlay welding is performed at predetermined thickness using a high strength different metal having high heat-resistance, endurance and corrosion resistance, such as stainless steel or nickel alloy. This overlay welding is often referred to a build-up welding. This is a method that a metal surface is coated by welding to improve corrosion resistance, endurance, abrasion resistance and stiffness when a metal with weak physical characteristics is used in very weakness environment, and is widely used because high mechanical and chemical characteristics can be adjusted with relatively low cost.

The overlay welding as the above is used by developing a variety of automatic apparatuses. For example, the Korean registered patent No. 909596 relates to an automatic overlay welding apparatus of a long pipe, and comprises a rotation chuck part in which a pipe is inserted and fixed and rotating the pipe; a pair of guide wire penetrating the pipe fixed at the rotation chuck to be placed horizontally in parallel; a tensile part drawing out the guide wire; a welding part supported by the guide wire to be capable of moving along an interior of the pipe, and performing a build-up welding into the interior of the pipe; and a controller managing that the pipe is rotated by the rotation chuck part simultaneously with moving the welding part toward one side to continuously perform the build-up welding while a welding bead is formed as a spiral on an inner surface of the pipe.

Further, the Korean registered patent No. 383014 relates to a hotwire TIG torch, relates to a hotwire TIG torch capable of performing the build-up welding of an inner surface of a pipe with small diameter and long length, and comprises a connection part; a body part connecting with the connection part, having appropriate length and having both ends connected with insulator; and an electrode part connected to the body part angularly with the longitudinal direction of the body part, thereby a build-up welding can be available to a pipe having inner diameter of at least 150 mm and an inner build-up welding can be available to the pipe having about 1.5 meter length. Thus this apparatus can be applied to the build-up welding of pipe interior with small diameter and long length.

This build-up welding apparatus disclosed above introduces TIG welding as a welding method.

The TIG welding has advantages that mechanical property and corrosion resistance are superior and working environment is clean, but has a problem of low productivity. To improve productivity, current should be elevated and welding speed should be increased. If high density current is used, however, serious depression phenomenon may be occurred at the surface of welding pool by strong arc power from arc pressure, and welding defects, i.e., undercut, humping bead and separate bead may be generated.

To improve productivity by elevating deposition rate, wire feeding speed should be elevated. However, time enough to absorb arc heat is insufficient when small wire of 1.0 or 1.2 mm is used, and the wire may get out of the welding pool without melting to form an unwelding wire even if the wire is fed by being a little went off the arc center. Because the productivity is getting lower when the unwelding wire is occurred, the welding is performed at sufficiently high current in a job site. The current should be elevated when the feed speed is elevated, however, the welding defects such as the undercut may be occurred and the depression of a base metal may be extended by the strong arc power. Thus, there is a shortcoming that application is difficult.

To solve the above problem, Korean patent application No. 2012-0096720 which is filed by the present applicant introduces a filler metal of plane shape. It was confirmed that the plane shape is superior to conventional filler metal of circular cross-section in welding characteristic.

The shape of cross-section is formed as curved shape and then welding characteristic is confirmed to be superior than the plane shaped filler metal by another research. Thus, it is actual condition that the filler metal of the variety of cross-section shapes is necessary to be manufactured.

### DISCLOSURE

### Technical Problem

The present invention is invented according to the necessity and invented for processing plane shape to form a filler metal having the variety of cross-section and providing a forming and feeding device of the filler metal for TIG welding capable of continuously feeding into a welding portion.

### Technical Solution

To achieve the above, the present invention provides a forming and feeding device of a filler metal for TIG welding which presses a filler metal of plane shape to form as curved cross-section which includes a case; a guide member installed on a front part of the case to guide the filler metal; a rotation roller revolving by a motor to feed the filler metal with supporting a lower surface of the filler metal, the filler metal guided by the guide member; a press roller located over the rotation roller to press a upper surface of the filler metal which is in contact with the rotation roller; and a press member pressing the press roller.

In some embodiments, a concave bent portion is formed on a circumstance of the rotation roller toward the circumstance direction, a convex bent portion is formed on a circumstance of the press roller corresponding to the bent portion of the rotation roller, and a cross-section shaped of the filler metal is formed by the bent portion.

In some other embodiments, the bent portion is symmetrical with respect to a center.

In still other embodiments, the bent portion is tertiary spline curved shape.

In yet other embodiments, the bent portion is arc shape.

In yet still other embodiments, the bent portion is a line shape of which a center is bent to be sloped.

In further embodiments, the bent portion is parabola shape.

In still further embodiments, the bent portion comprises a center portion of horizontally formed and an inclined portion sloped from an end of the center portion.

In yet further embodiments, the center portion further comprises an arc portion.

In other embodiments of the present invention further includes a lower guide roller disposed at the right of the rotation roller to support a lower surface of the process complete filler metal; and an upper guide roller disposed at the right of the press roller to contact with an upper surface of the process complete filler metal.

In some other embodiments, the upper guide roller includes a press device which increases contact power for contacting with the filler metal.

### Advantageous Effects

The forming and feeding device of a filler metal for TIG welding according to the present invention continuously processes and feeds cross-section shape of the filler metal such that there is convenience to install and use. And the plane shaped filler metal can be bent into any cross-section shape by changing a processing roller such that the variety of cross-sectional shaped filler metal can be fed.

### DESCRIPTION OF DRAWINGS

FIG. 1 is a view illustrating a site where a forming and feeding device of a filler metal for TIG welding according to the present invention is installed.

FIG. 2 is a view illustrating a forming and feeding device of a filler metal for TIG welding according to the present invention is installed.

FIG. 3 is a side view of a rotation roller and a press roller in FIG. 2.

FIG. 4 illustrates various embodiments of a bent portion.

FIG. 5 illustrates another embodiment in which the rotation roller and the press roller in FIG. 2 are plural.

FIG. 6 is a side view of guide rollers in FIG. 2.

### MODE FOR INVENTION

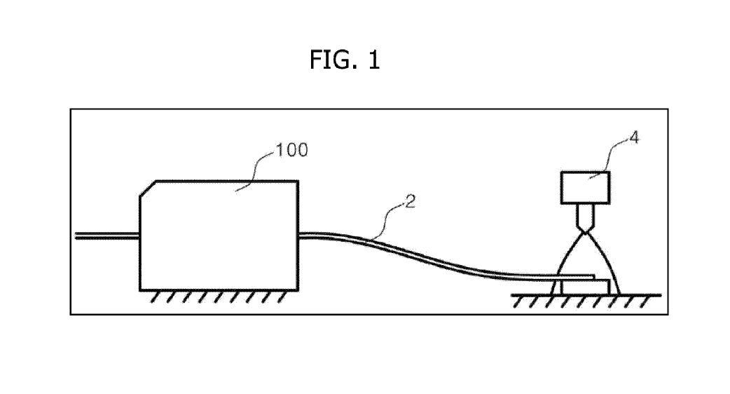

A forming and feeding device of a filler metal for TIG welding 100 according to the present invention, as shown in FIG. 1, has feature of forming a plane shaped filler metal 2 into require cross-section shape and feeding into a torch 4. The filler metal 2 of which cross-section shape is changed by the forming and feeding device 100 is directly fed into the torch 4.

In case of need, it may be embodied that the filler metal fed by the feeding device working together with additional feeding device.

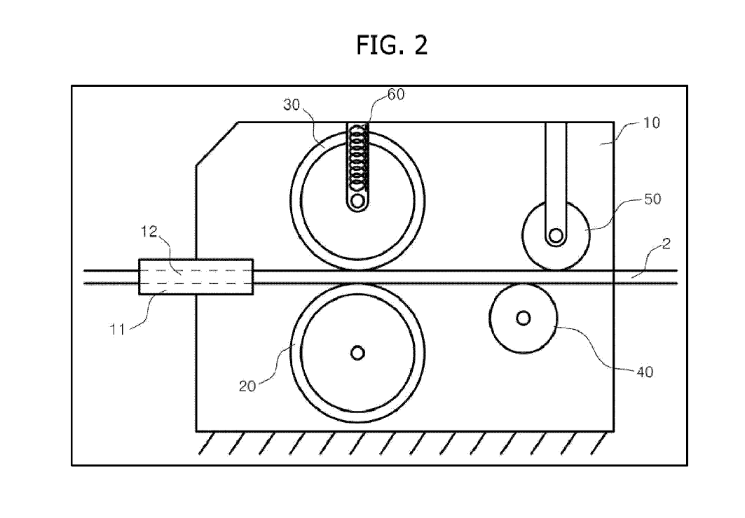

The forming and feeding device of a filler metal for TIG welding according to the present invention, as shown in FIG. 2, includes a case 10 supporting entire device, a rotation roller 20 rotating with pressing and forming a plane shaped filler metal 2, a press roller 30 pressing the filler metal 2 over the rotation roller 20, a lower guide roller 40 aligning the forming complete filler metal 2, and an upper guide roller 50 corresponding to the lower guide roller and pressing the filler metal 2 disposed on the lower guide roller 40.

The case 10 includes two plane boards and is formed of metal according to constructional characteristic but not limited in material. Components for forming the filler metal 2 are located in the plane board.

A guide member 11 is located in a front surface of the case 10. The filler metal 2 is inserted through the guide member 11, straight property into the case 10 is provided.

A rectangular guide hole 12 in which the filler metal 2 is inserted is formed in the guide member 11 to prevent the filler metal 2 from vibrating and trembling.

A rotation roller 20 is located at the right of the guide member 20.

The rotation roller 20 is operated by additional motor 25. The filler metal 2 is moved by rotation of the rotation roller 20. An upper end of the rotation roller 20 is disposed to locate on an extension line of the guide hole 12 which is formed at the guide member 11.

In addition, the press roller 30 is located over the rotation roller 20 and includes additional press device 60.

The filler metal 2 is located between the rotation roller 20 and the press roller 30. The press roller 30 presses the filler metal using the press device 60. The rotation roller 20 moves the filler metal which pressed by the press roller 30, by rotation.

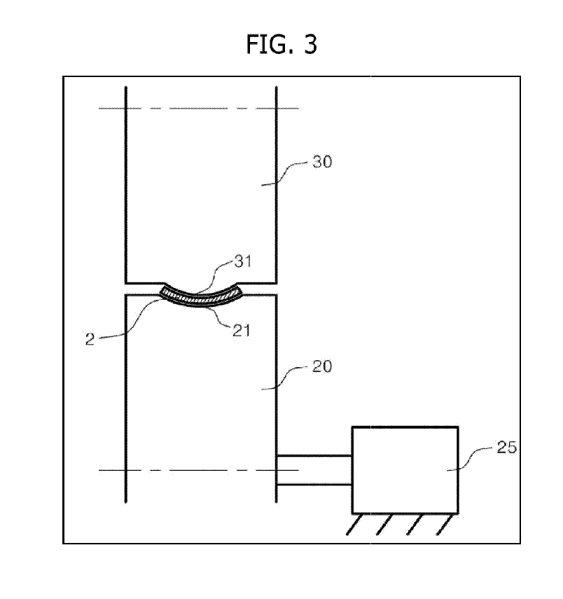

Bent portions 21 and 31 for changing a cross-section of the plane filler metal 2 are formed at circumstances of the rotation roller 20 and the press roller 30, as shown in FIG. 3.

The bent portion 21 of the rotation roller 20 is concave shape and the bent portion 31 of the press roller 30 is convex shape corresponding to the concave shape.

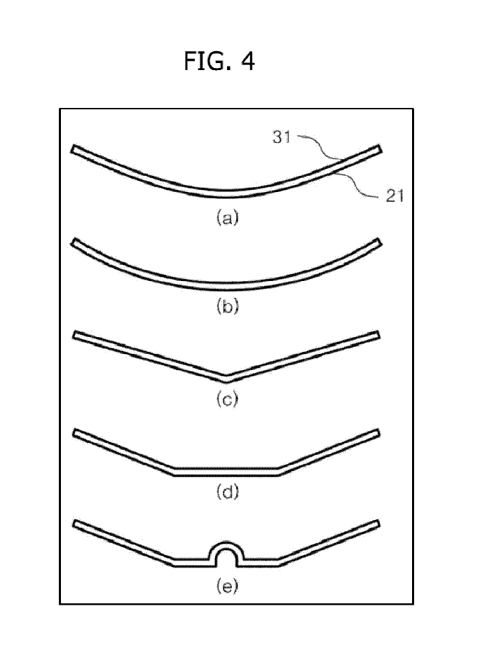

The bent portion 31, as shown in FIG. 4(a), may be defined into tertiary spline curve with zero slope at a center.

Secondary parabola may be defined similarly with the spline curve.

As shown in FIG. 4(b) it may be defined as arc shape, and it may be embodied as an inclined line from the center in consideration of process convenience as shown in FIG. 4(c).

As shown in FIG. 4(d) it may be embodied to include a horizontal shaped center portion and an inclined portion from an end of the center portion, and may be further formed of an arc portion at the center portion to guide the filler metal 2 as shown in FIG. 4(e).

The cross-section of the filler metal 2 may be formed into asymmetrically besides the formation drawn in FIG. 4. These geometric shapes may be realized by changing the bent portions 21 and 31.

Thus the filler metal 2 after passing the rotation roller 20 and the press roller 30 is transformed from the plane shaped cross-section into the bent portions 21 and 31.

The press device 60 is a component for pressing the press roller 30 and may be formed of an elastic body using such a spring or a screw. These press construction may be formed by conventional methods.

The press roller 30 may be formed of a structure capable of separating from the case 10 using a simple method thereby providing convenience during the filler metal 20 injection.

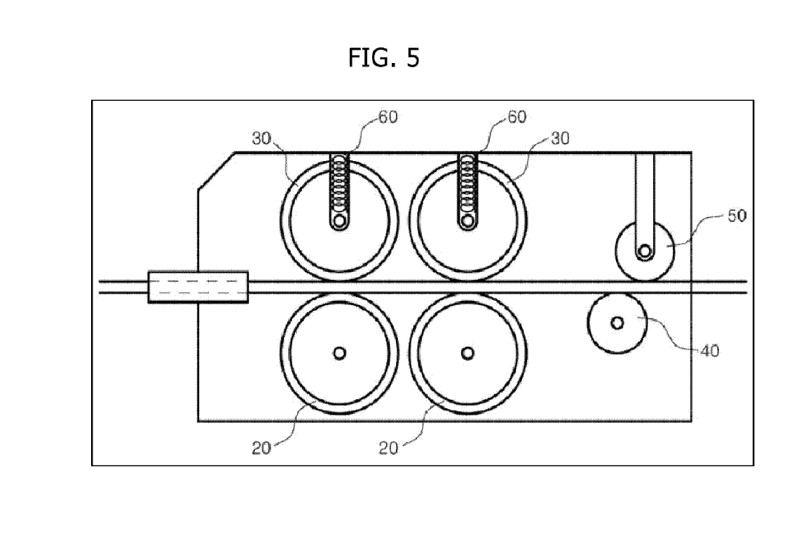

In case of need, as shown in FIG. 5, the rotation roller 20 and the press roller 30 may consist in plural number.

If the filler metal of metal is formed by only an initial roller, the shape may be different from the bent portions 21 and 31 caused by spring-back. Therefore, IF the plurality of the rollers are applied, there is an advantage that more elaborate cross-section may be formed.

The lower guide roller 40 may be disposed at the right of the rotation roller 20, and the filler metal 2 after changing the cross-section shape through the rotation roller 20 is passing the upper end of the lower guide roller 40.

The upper guide roller 50 is located at the right of the press roller 30, and the upper guide roller 50 conducts an act by which the filler metal 2 located on the upper end of the lower guide roller 40 is pressed.

Then, the upper guide roller 50 is located at the right of the lower guide roller 40 and presses downward the filler metal 2 which is transformed upward, thereby providing straight property.

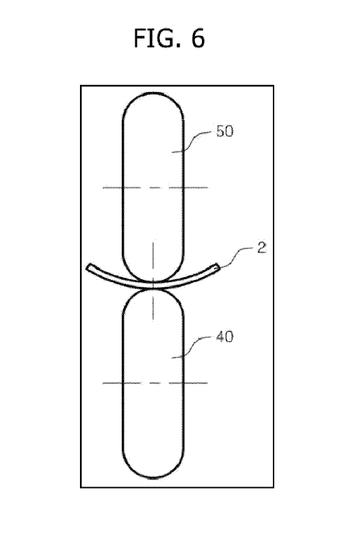

Since the upper guide roller 50 and the lower guide roller 40 just guides location without forming the filler metal, as shown in FIG. 6, it is preferable that the rollers is construct to contact with a portion of a surface of the filler metal 2.

The upper guide roller 50 includes additional press device, and the press device may be embodied to provide spare pressure using an elastic body or a screw and be applied by conventional methods.

The present invention was illustrated and described with reference to exemplary embodiments. It should be noted, however, that the inventive concepts are not limited to the exemplary embodiments, and the exemplary embodiments are provided only to disclose the inventive concepts and let those skilled in the art know the category of the inventive concepts.

[Description of symbols]

| | |
|---|---|
| 2: Filler metal | 4: Torch |

| | |
|---|---|
| 10: Case | 11: Guide portion |
| 12: Guide hole | 20: Rotation roller |
| 21: Bent portion | 30: Press roller |
| 31: Bent portion | 40: Lower guide roller |
| 50: Upper guide roller | 60: Press device |

100: Forming and feeding a filler metal

1-11. (canceled)

12. A forming and feeding device of a filler metal for TIG welding which presses a filler metal of plane shape to form as curved cross-section comprising:
a case;
a guide member installed on a front part of the case to guide the filler metal;
a rotation roller revolving by a motor to feed the filler metal with supporting a lower surface of the filler metal, the filler metal guided by the guide member;
a press roller located over the rotation roller to press a upper surface of the filler metal which is in contact with the rotation roller; and
a press member pressing the press roller.

13. The forming and feeding device of a filler metal for TIG welding of claim 12, wherein a concave bent portion is formed on a circumstance of the rotation roller toward the circumstance direction, and a convex bent portion is formed on a circumstance of the press roller corresponding to the bent portion of the rotation roller.

14. The forming and feeding device of a filler metal for TIG welding of claim 13, wherein the bent portion is symmetrical with respect to a center.

15. The forming and feeding device of a filler metal for TIG welding of claim 13, wherein the bent portion is tertiary spline curved shape.

16. The forming and feeding device of a filler metal for TIG welding of claim 13, wherein the bent portion is arc shape.

17. The forming and feeding device of a filler metal for TIG welding of claim 13, wherein the bent portion is a line shape of which a center is bent to be sloped.

18. The forming and feeding device of a filler metal for TIG welding of claim 13, wherein the bent portion is parabola shape.

19. The forming and feeding device of a filler metal for TIG welding of claim 13, wherein the bent portion comprises a center portion of horizontally formed and an inclined portion sloped from an end of the center portion.

20. The forming and feeding device of a filler metal for TIG welding of claim 19, wherein the center portion further comprises an arc portion.

21. The forming and feeding device of a filler metal for TIG welding of claim 14, further comprising:
a lower guide roller disposed at the right of the rotation roller to support a lower surface of the process complete filler metal; and
an upper guide roller disposed at the right of the press roller to contact with an upper surface of the process complete filler metal.

22. The forming and feeding device of a filler metal for TIG welding of claim 21, wherein the upper guide roller includes a press device which increases contact power for contacting with the filler metal.

23. The forming and feeding device of a filler metal for TIG welding of claim 14, wherein the bent portion is tertiary spline curved shape.

24. The forming and feeding device of a filler metal for TIG welding of claim 14, wherein the bent portion is arc shape.

25. The forming and feeding device of a filler metal for TIG welding of claim 14, wherein the bent portion is a line shape of which a center is bent to be sloped.

26. The forming and feeding device of a filler metal for TIG welding of claim 14, wherein the bent portion is parabola shape.

27. The forming and feeding device of a filler metal for TIG welding of claim 14, wherein the bent portion comprises a center portion of horizontally formed and an inclined portion sloped from an end of the center portion.

28. The forming and feeding device of a filler metal for TIG welding of claim 27, wherein the center portion further comprises an arc portion.
